(19) United States
(12) Patent Application Publication
(10) Pub. No.: US 2021/0348045 A1
(43) Pub. Date: Nov. 11, 2021

(54) COMPOSITIONS COMPRISING 2,3,3,3-TETRAFLUOROPROPENE

(71) Applicant: SRF LIMITED, Gurgaon (IN)

(72) Inventors: Prashant YADAV, Gurgaon (IN); Manoj Kumar MISHRA, Gurgaon (IN); Aditya SHARMA, Gurgaon (IN)

(21) Appl. No.: 17/283,186

(22) PCT Filed: Feb. 12, 2019
(86) PCT No.: PCT/IN2019/050110

§ 371 Date: Apr. 6, 2021

(30) Foreign Application Priority Data
Oct. 10, 2018 (IN) 201811038433

(51) Int. Cl. C09K 5/04

(52) U.S. Cl. CPC C09K 5/045; C09K 2205/106; C09K 2205/40; C09K 2205/22; C09K 2205/34; C09K 2205/126

(57) ABSTRACT

The present invention relates to compositions for use in refrigeration, air-conditioning, and heat pump systems wherein the composition comprises a 2,3,3,3-tetrafluoropropene and at least one other component. The compositions of the present invention are useful in processes for producing cooling or heat, as heat transfer fluids, foam blowing agents, aerosol propellants, and fire suppression and fire extinguishing agents.

### FIELD OF THE INVENTION

The present invention relates to compositions for use in refrigeration, air-conditioning, and heat pump systems wherein the composition comprises a fluoroolefin and at least one other component. The compositions of the present invention are useful in processes for producing cooling or heat, as heat transfer fluids, foam blowing agents, aerosol propellants, and fire suppression and fire extinguishing agents.

### BACKGROUND OF THE INVENTION

The refrigeration industry has been working for the past few decades to find replacement refrigerants for the ozone depleting chlorofluorocarbons (CFCs) and hydrochlorofluorocarbons (HCFCs) being phased out as a result of the Montreal Protocol. The solution for most refrigerant producers has been the commercialization of hydrofluorocarbon (HFC) refrigerants. The new HFC refrigerants, HFC-134a being the most widely used at this time, have zero ozone depletion potential and thus are not affected by the current regulatory phase out as a result of the Montreal Protocol.

Refrigerant is the substance which is used as working fluid in a thermodynamic cycle, undergoes a phase change from liquid to vapour and produces cooling. These are used in refrigeration, air conditioning, and heat pumping systems. They absorb heat from one area, such as an air conditioned space, and reject it into another, such as outdoors, usually through evaporation and condensation, respectively. These phase changes occur both in absorption and mechanical vapour compression refrigeration systems, but they do not occur in systems operating on a gas cycle using a fluid such as air.

One important type of refrigeration system is known as a “low temperature refrigeration system.” Such systems are particularly important to the food manufacture, distribution, transport, and retail industries in that they play a vital role in ensuring that food which reaches the consumer is both fresh and fit to eat. In such low temperature refrigeration systems, a commonly used refrigerant liquid has been R-404A (the combination of R125:R143a:R134a in an approximate 44:52:4 weight ratio is referred to in the art as R404A. R404A has an estimated high Global Warming Potential (GWP) of 3922.

There has thus been an increasing need for new fluorocarbon and hydrofluorocarbon compounds and compositions that are attractive alternatives to the compositions heretofore used in these and other applications. For example, it has become desirable to retrofit chlorine-containing refrigeration systems by replacing chlorine-containing refrigerants with non-chlorine-containing refrigerant compounds that will not deplete the ozone layer, such as hydrofluorocarbons (HFC's). Industry in general and the heat transfer industry in particular are continually seeking new fluorocarbon based mixtures that offer alternatives to, and are considered environmentally safer substitutes for, CFCs and HCFCs. It is generally considered important, however, at least with respect to heat transfer fluids, that any potential substitute must also possess those properties present in many of the most widely used fluids, such as excellent heat transfer properties, chemical stability, low- or no-toxicity, non-flammability and/or lubricant compatibility, among others.

With regard to efficiency in use, it is important to note that a loss in refrigerant thermodynamic performance or energy efficiency may have secondary environmental impacts through increased fossil fuel usage arising from an increased demand for electrical energy.

Flammability is a term used to mean the ability of a composition to ignite and/or propagate a flame. For refrigerants and other heat transfer compositions, the lower flammability limit (“LFL”) is the minimum concentration of the heat transfer composition in air that is capable of propagating a flame through a homogeneous mixture of the composition and air under test conditions specified in ASTM (American Society of Testing and Materials) E681-04. The upper flammability limit (“UFL”) is the maximum concentration of the heat transfer composition in air that is capable of propagating a flame through a homogeneous mixture of the composition and air under the same test conditions.

Flammability is an important property for many applications. That is, it is considered either important or essential in many applications, including particularly in heat transfer applications, to use compositions which are non-flammable. Thus, it is frequently beneficial to use in such compositions compounds which are nonflammable. As used herein, the term “nonflammable” refers to compounds or compositions which are determined to be nonflammable as determined in accordance with ASTM standard E-681, dated 2002, which is incorporated herein by reference. Unfortunately, many HFC's which might otherwise be desirable for use in refrigerant compositions are not nonflammable as that term is used herein. For example, the fluoroalkene 1,1,1-trifluorpropene (HFO1243zf) is flammable and therefore not viable for use in many applications.

U.S. Patent Pub. No. 2004/0061091 discloses a refrigerant composition comprising 45-50 weight percent R134a, 45-50 weight percent R125, 3-5 weight percent R32, and 1-4 weight percent of the hydrocarbon component, the hydrocarbon component comprising one or more hydrocarbons selected from Group A and one or more hydrocarbons selected from Group B, wherein the Group A hydrocarbon comprises R290 and the Group B hydrocarbon comprises R600a.

EP 1985681B1 specifically discloses a composition comprising:
i) R32 (23 wt %), R125 (25 wt %) and R1234yf (52 wt %),
ii) R32 (15 wt %)/R125 (45 wt %) and R1234yf (40 wt %), or
iii) R32 (10 wt %), R125 (60 wt %) and R1234yf (30 wt %).
U.S. Pat. No. 9,982,180 discloses a heat transfer composition consisting of: (a) about 10% by weight of R32; (b) about 69% by weight of R125; (c) about 8% by weight of HFO1234yf and (d) about 13% by weight of trans HFO1234ze, with the weight percent being based on the total of the components (a)-(d) in the composition.

All the above composition have significant amount of R125 which contributes to the higher GWP of these compositions.

Applicants have thus come to appreciate a need for compositions, and particularly heat transfer compositions, that are highly advantageous in heating and cooling systems and methods, particularly vapor compression heating and cooling systems, and even more particularly low temperature refrigerant systems, including systems which are used with and/or have been designed for use with R-404A.

The present invention provides a refrigerant composition comprising:
10% by weight to 35% by weight of R32;
10% by weight to 35% by weight of R1234yf;
0% by weight to 20% by weight of R125;
20% by weight to 50% by weight of tetrafluoroethane;
0% by weight to 10% by weight of heptafluoropropane;
0% by weight to 10% by weight of difluoroethane; and
0% by weight to 8% by weight of CO₂.

### OBJECT OF THE INVENTION

The main object of the present invention is to provide a composition for use in refrigeration, air-conditioning and heat pump systems comprising a fluoroolefin and at least one other component selected from R32, R125, tetrafluoroethane, heptafluoropropane, difluoroethane and CO₂.

### SUMMARY OF THE INVENTION

The present invention provides a refrigerant composition comprising:
10% by weight to 35% by weight of R32;
10% by weight to 35% by weight of R1234yf;
0% by weight to 20% by weight of R125;
20% by weight to 50% by weight of tetrafluoroethane;
0% by weight to 10% by weight of heptafluoropropane;
0% by weight to 10% by weight of difluoroethane; and
0% by weight to 8% by weight of CO₂.

### DETAILED DESCRIPTION OF THE INVENTION

The term “tetrafluoroethane” as used herein in the present invention refers to either 1,1,2,2-tetrafluoroethane or 1,1,1,2-tetrafluoroethane.

The term “difluoroethane” as used herein in the present invention refers to either 1,1-difluoroethane or 1,2-difluoroethane.

The term “heptafluoropropane” as used herein in the present invention refers to either 1,1,1,2,3,3,3-heptafluoropropane or 1,1,1,2,2,3,3-heptafluoropropane.

The term “about” as used in the present invention refers to 10% deviation from the specified value in both side.

The various refrigerants as used in the present invention are described in the Table-1 below.

TABLE 1

| Refrigerant | Chemical name | Chemical formula |
|---|---|---|
| R32 | Difluoromethane | CH₂F₂ |
| R125 | Pentafluoroethane | CF₃CHF₂ |
| R-134 | 1,1,2,2-tetrafluoroethane | CHF₂CHF₂ |
| R134a | 1,1,1,2-tetrafluoroethane | CH₂FCF₃ |
| R152a | 1,1-difluoroethane | CHF₂CH₃ |
| R152 | 1,2-difluoroethane | CH₂FCH₂F |
| R227ea | 1,1,1,2,3,3,3-heptafluoropropane | CF₃CHFCF₃ |
| R227ca | 1,1,1,2,2,3,3-Heptafluoropropane | CHF₂CF₂CF₃ |
| R1234yf | 2,3,3,3-tetrafluoropropene | CF₃CF═CH₂ |

In an aspect, the present invention provides a refrigerant composition comprising:
25% by weight to 35% by weight of R32;
12% by weight to 30% by weight of R1234yf;
2% by weight to 15% by weight of R125;
25% by weight to 48% by weight of tetrafluoroethane;
0% by weight to 5% by weight of heptafluoropropane;
0% by weight to 5% by weight of difluoroethane; and
0% by weight to 2% by weight of CO₂.

In an embodiment, the present invention provides refrigerant composition comprising:
20% by weight to 25% by weight of R32;
25% by weight to 30% by weight of R1234yf;
10% by weight to 15% by weight of R125;
25% by weight to 45% by weight of tetrafluoroethane; and
2% by weight to 5% by weight of heptafluoropropane.

In another embodiment, the present invention provides a refrigerant composition comprising R32, R1234yf, R125, R134a, and R227ea comprises the steps of:
a) mixing 227ea, 134a and 1234yf to get a mixture;
b) adding R125 and R32 to the mixture of step a),
wherein the mixing is assisted with recirculation or agitators.
The addition of R125 and R32 is preferentially done one by one, i.e., addition of R125 followed by addition of R32.

In another embodiment, the present invention provides a refrigerant composition 1 (C-1) comprising:
about 25% by weight of R32;
about 30% by weight of R1234yf;
about 15% by weight of R125;
about 25% by weight of tetrafluoroethane; and
about 5% by weight of heptafluoropropane.

In another embodiment, the present invention provides a refrigerant composition comprising:
20% by weight to 25% by weight of R32;
20% by weight to 28% by weight of R1234yf;
10% by weight to 15% by weight of R125;
20% by weight to 25% by weight of 134a;
2% by weight to 5% by weight of 227ea; and
0.5% by weight to 2% by weight of CO₂.

In another embodiment, the present invention provides refrigerant composition comprising R32, R1234yf, R125, R134a, R227ea, and carbon dioxide comprises the steps of:
a) mixing 227ea, 134a and 1234yf to get first mixture;
b) adding R125 and R32 to the mixture of step a) to get a second mixture;
c) adding carbon dioxide to the second mixture,

wherein the mixing is assisted with recirculation or agitators.

The addition of R125 and R32 is preferentially done one by one, i.e., addition of R125 followed by addition of R32.

In another embodiment, the present invention provides a refrigerant composition 1a (C-1a) comprising:
about 25% by weight of R32;
about 28% by weight of R1234yf;
about 15% by weight of R125;
about 25% by weight of 134a;
about 5% by weight of 227ea; and
about 2% by weight of CO₂.

In another embodiment, the present invention provides a refrigerant composition comprising:
28% by weight to 32% by weight of R32;
12% by weight to 16% by weight of R1234yf;
8% by weight to 12% by weight of R125;
43% by weight to 47% by weight of 134a; and
0% by weight to 8% by weight of CO₂.

In another embodiment, the present invention provides refrigerant composition comprising R32, R1234yf, R125, R134a, and carbon dioxide comprises the steps of:
a) mixing 134a and 1234yf to get first mixture;
b) adding R125 and R32 to the mixture of step a) to get a second mixture;
c) adding carbon dioxide to the second mixture,
wherein the mixing is assisted with recirculation or agitators.

The addition of R125 and R32 is preferentially done one by one, i.e., addition of R125 followed by addition of R32.

In another embodiment, the present invention provides a refrigerant composition comprising:
25% by weight to 30% by weight of R32;
10% by weight to 15% by weight of R1234yf;
8% by weight to 12% by weight of R125;
30% by weight to 50% by weight of tetrafluoroethane; and
2% by weight to 8% by weight of CO₂.

In another embodiment, the present invention provides a refrigerant composition 2a (C-2a) comprising:
about 28% by weight of R32;
about 15% by weight of R1234yf;
about 10% by weight of R125;
about 45% by weight of 134a; and
about 2% by weight of CO₂.

In another embodiment, the present invention provides a refrigerant composition comprising:
25% by weight to 30% by weight of R32;
10% by weight to 15% by weight of R1234yf;
8% by weight to 15% by weight of R125; and
40% by weight to 50% by weight of tetrafluoroethane

In another embodiment, the present invention provides a refrigerant composition comprising R32, R1234yf, R125, and R134a comprises the steps of:
a) mixing 134a and 1234yf to get first mixture;
b) adding R125 and R32 to the mixture of step a) to get the composition;

wherein the mixing is assisted with recirculation or agitators.

The addition of R125 and R32 is preferentially done one by one, i.e., addition of R125 followed by addition of R32.

In another embodiment, the present invention provides a refrigerant composition comprising:
25% by weight to 30% by weight of R32;
10% by weight to 15% by weight of R1234yf;
8% by weight to 15% by weight of R125; and
40% by weight to 50% by weight of 134a

In a particular embodiment, the present invention provides a refrigerant composition 2 (C-2) comprising:
about 30% by weight of R32;
about 15% by weight of R1234yf;
about 10% by weight of R125; and
about 45% by weight of 134a.

In another embodiment, the present invention provides a refrigerant composition comprising:
20% by weight to 25% by weight of R32;
25% by weight to 30% by weight of R1234yf;
10% by weight to 15% by weight of R125;
20% by weight to 30% by weight of tetrafluoroethane; and
2% by weight to 10% by weight of difluoroethane.

In another embodiment, the present invention provides a refrigerant composition comprising:
23% by weight to 27% by weight of R32;
28% by weight to 32% by weight of R1234yf;
13% by weight to 17% by weight of R125;
23% by weight to 27% by weight of 134a; and
3% by weight to 7% by weight of R152a.

In another embodiment, the present invention provides refrigerant composition comprising R32, R1234yf, R125, R134a, and 152a comprises the steps of:
a) mixing 152a, 134a and 1234yf to get a mixture;
b) adding R125 and R32 to the mixture of step a) to get the composition,

wherein the mixing is assisted with recirculation or agitators.

The addition of R125 and R32 is preferentially done one by one, i.e., addition of R125 followed by addition of R32.

In another embodiment, the present invention provides a refrigerant composition 3 (C-3) comprising:
about 25% by weight of R32;
about 30% by weight of R1234yf;
about 15% by weight of R125;
about 25% by weight of 134a; and
about 5% by weight of R152a.

In another embodiment, the present invention provides a refrigerant composition comprising:
30% by weight to 35% by weight of R32;
12% by weight to 15% by weight of R1234yf;
42% by weight to 48% by weight of tetrafluoroethane and
2% by weight to 5% by weight of heptafluoropropane.

In another embodiment, the present invention provides a refrigerant composition comprising:
30% by weight to 35% by weight of R32;
13% by weight to 17% by weight of R1234yf;
42% by weight to 48% by weight of 134a; and
4% by weight to 6% by weight of R227ea.

In another embodiment, the present invention provides refrigerant composition comprising R32, R1234yf, R134a, and R227ea comprises the steps of:
a) mixing 227ea, 134a and 1234yf to get a mixture;
b) adding R32 to the mixture of step a) to get the composition,

wherein the mixing is assisted with recirculation or agitators.

In another embodiment, the present invention provides a refrigerant composition 4 (C-4) comprising:
about 33.7% by weight of R32;
about 14.7% by weight of R1234yf;
about 46.6% by weight of 134a and
about 5% by weight of R227ea.

The compositions of the present invention are preferably non-azeotropic compositions.

As used herein, a refrigerant is defined as a heat transfer fluid that undergoes a phase change from liquid to gas and back again during a cycle used to transfer of heat.

The recirculation is carried out using a pump to ensure homogeneity of the composition.

Non-azeotropic composition is a mixture of two or more substances that behaves as a simple mixture rather than a single substance. One way to characterize a non-azeotropic composition is that the vapor produced by partial evaporation or distillation of the liquid has a substantially different composition as the liquid from which it was evaporated or distilled, that is, the admixture distills/refluxes with substantial composition change.

The composition of the present invention has lower molecular weight thus has large enthalpy of evaporation. This results in higher cooling capacity. The higher the cooling capacity, the lower will be energy loss across compression and thus higher will be COP value. The comparative data for enthalpy of evaporation is given in Table-2 below.

TABLE 2

| | Molar mass (Kg/Kmol) | | Enthalpy (kj/kg) | |
|---|---|---|---|---|
| | at −25° C. in | at 25° C. in | at −25° C. in | at 25° C. in |
| Refrigerant | vapour phase | liquid phase | vapour phase | liquid phase |
| R404a | 97.604 | 97.604 | 352.33 | 236.3 |
| Composition 1 | 87.488 | 87.488 | 386.02 | 236.8 |
| Composition 2 | 81.133 | 81.133 | 406.65 | 237.71 |
| Composition 1a | 85.403 | 85.403 | 388.47 | 237.24 |
| Composition 2a | 79.813 | 79.813 | 407.69 | 238.08 |
| Composition 3 | 84.083 | 84.083 | 395.68 | 237.51 |
| Composition 4 | 79.189 | 79.189 | 413.29 | 237.96 |

Coefficient of performance (COP) is the amount of heat removed divided by the required energy input to operate the cycle. The higher the COP, the higher is the energy efficiency. COP is directly related to the energy efficiency ratio (EER) that is the efficiency rating for refrigeration or air conditioning equipment at a specific set of internal and external temperatures.

The composition 2 of the present invention has COP of about 110 to 113.

The composition 3 of the present invention has COP of about 100 to 105.

Flammability is a term used to mean the ability of a composition to ignite and/or propagate a flame. Determination of whether a refrigerant compound or mixture is flammable or non-flammable can be done by testing under the conditions of ASTM-681. The compositions of the present invention are mostly non-flammable.

Global warming potential (GWP) is an index for estimating relative global warming contribution due to atmospheric emission of a kilogram of a particular greenhouse gas compared to emission of a kilogram of carbon dioxide. GWP can be calculated for different time horizons showing the effect of atmospheric lifetime for a given gas. The GWP for the 100-year time horizon is commonly the value referenced. For mixtures, a weighted average can be calculated based on the individual GWPs for each component. The standard GWP values for R22, R32, R125 and tetrafluoroethane has been taken from IIPCC 5^{th} Assessment report 2014 (AR5). The GWP of the refrigerant mixture has been derived from mass fraction and the corresponding GWP values.

The compositions of the present invention has lower GWP value as compared with R-404 shown in the below Table-3.

TABLE 3

| Refrigerant | GWP |
|---|---|
| R-404A | 3920 |
| Composition 1 | 1214 |
| Composition 1a | 1214 |
| Composition 2 | 1197 |
| Composition 2a | 1183 |
| Composition 3 | 1059 |
| Composition 4 | 1056 |

Ozone depletion potential (ODP) is a number that refers to the amount of ozone depletion caused by a substance. The ODP is the ratio of the impact on ozone of a chemical compared to the impact of a similar mass of CFC-11 (fluorotrichloromethane). Thus, the ODP of CFC-11 is defined to be 1.0. Other CFCs and HCFCs have ODPs that range from 0.01 to 1.0. HFCs have zero ODP because they do not contain chlorine or other ozone depleting halogens. The composition of the present invention has zero ODP value.

In another embodiment of this aspect of the present invention, the refrigerant composition may contain optional components selected from the group consisting of lubricants, dyes (including Ultra Violet dyes), solubilizing agents, compatibilizers, stabilizers, tracers, perfluoropolyethers, anti-wear agents, extreme pressure agents, corrosion and oxidation inhibitors, metal surface energy reducers, metal surface deactivators, free radical scavengers, foam control agents, viscosity index improvers, pour point depressants, detergents, viscosity adjusters, and mixtures thereof. Indeed, many of these optional other components fit into one or more of these categories and may have qualities that lend themselves to achieve one or more performance characteristic.

In another embodiment of this aspect of the present invention, the refrigerant compositions are non-azeotropic mixture.

In another embodiment of this aspect of the present invention, the refrigerant composition is preferably charged in liquid form.

Additionally the composition of the present invention comprises a flame retardant, selected from phosphorus-based materials and non-phosphorus-based materials, to reduce the flammability of compositions.

The non-phosphorus-based materials comprises inert filler materials, such as calcium carbonate, aluminium trihydrate, magnesium hydroxide and calcium carbonate. Similarly the phosphorus-based flame-retardants comprises salt of melamine and bis(pentaerythritol phosphate) phosphoric acid and ammonium polyphosphate.

The refrigerant composition of the present invention has higher specific heat capacity as given in Table-4 below. Cp (Specific Heat in constant pressure) is the amount of heat required to increase temperature by 1° C. when heat is given at constant pressure, Cv (Specific heat in constant volume) means the amount of heat required to increase temperature by 1° C., when heat is given at constant volume.

TABLE 4

| | Cp/Cv at −25° | Cp/Cv at −25° | Cp/Cv at 25° |
|---|---|---|---|
| | C. in liquid | C. in vapour | C. in liquid |
| Refrigerant | phase | phase | phase |
| R404a | 1.5327 | 1.1859 | 1.6678 |
| Composition 1 | 1.5631 | 1.1966 | 1.6918 |
| Composition 2 | 1.5874 | 1.2117 | 1.7119 |
| Composition 1a | 1.5768 | 1.2007 | 1.7142 |
| Composition 2a | 1.5977 | 1.2141 | 1.7303 |
| Composition 3 | 1.5657 | 1.2009 | 1.6922 |
| Composition 4 | 1.593 | 1.2149 | 1.7168 |

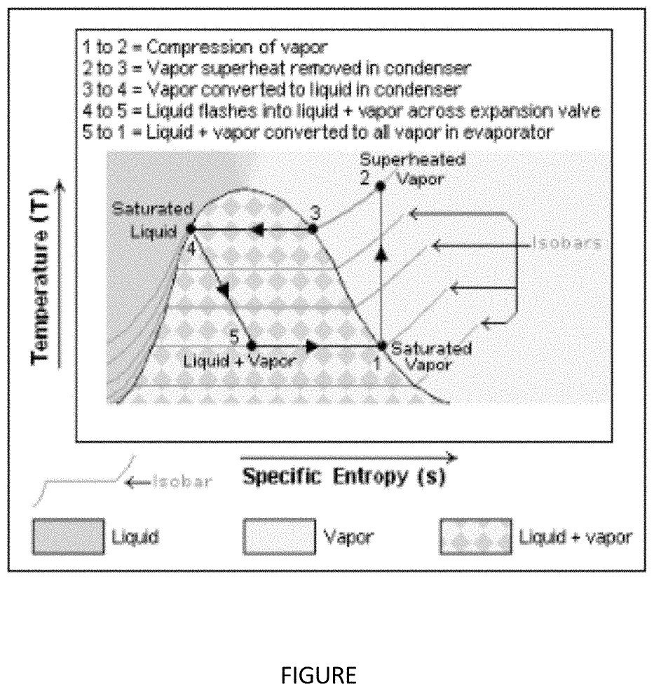

In another embodiment of this aspect, the present invention provides a refrigeration process using the refrigerant composition comprising the steps of:
a) condensing the refrigerant composition;
b) evaporating the refrigerant composition.
The vapor compression refrigeration cycle is given in FIG. 1.

Further, the refrigerant composition of present invention has higher thermal conductivity.

TABLE 5

| | Thermal conductivity | Thermal conductivity |
|---|---|---|
| | (mW/m-K) at −25° C. in | (mW/m-K) at 25° C. in |
| Refrigerant | liquid phase | liquid phase |
| R404a | 82.918 | 62.714 |
| Composition 1 | 104.76 | 80.781 |
| Composition 2 | 113.14 | 87.494 |
| Composition 1a | 114.99 | 81.734 |
| Composition 2a | 123.53 | 87.911 |
| Composition 3 | 107.19 | 82.914 |
| Composition 4 | 116.86 | 90.662 |

The refrigerant compositions of the present invention may be used in stationary or mobile air conditioning systems or heat exchanger systems. Preferably, the refrigerant compositions would be utilized in domestic room air conditioning systems.

The present invention thus provides an R404a replacement refrigerant compositions that are compatible with existing mineral oil and alike lubricants and do not require replacement of the expensive devices in the legacy system.

R32 is commercially available or may be prepared by methods known in the art, such as by dechlorofluorination of methylene chloride.

R125 is commercially available or may be prepared by methods known in the art, such as dechlorofluorination of 2,2-dichloro-1,1,1-trifluoroethane as described in U.S. Pat. No. 5,399,549, incorporated herein by reference.

Tetrafluoroethane is commercially available or may be prepared by methods know in the art, such as by the hydrogenation of 1,1-dichloro-1,2,2,2-tetrafluoroethane (i.e., CCI₂FCF₃ or CFC-114a) to 1,1,1,2-tetrafluoroethane.

Heptafluoropropane is commercially available or may be prepared by methods known in the art.

R1234yf is commercially available or may be prepared by methods known in the art. It is against this and other backgrounds, which shall be filed in a detailed manner in complete specifications, in due course, the present invention is brought out and explained in following non-limiting examples.

It will be apparent to those skilled in the art that various modifications and variations can be made in the present invention and specific examples provided herein without departing from the spirit and scope of the invention. Thus, it is intended that the present invention covers the modifications and variations of this invention that come within the scope of any claims and their equivalents.

### EXAMPLE

The refrigerant compositions according to the invention having composition of R125:R134a:R32:R227ea:R1234yf were prepared at 20 to 30° C. at atmospheric pressure and tested with standard ASHRAE modeling program maintaining indoor at 5° C. dry bulb temperature (DBT) and 4° C. wet bulb temperature (WBT) and outdoor at 35 DBT and 24 WBT.

The analytical results of the various refrigerant compositions are shown in below tables.

TABLE 6
Analysis at 25° C. in liquid phase

| | R404a | C-1 | C-1a | C-2 | C-2a | C-3 | C-4 |
|---|---|---|---|---|---|---|---|
| Pressure | 12.546 | 12.309 | 13.786 | 12.173 | 13.56 | 12.048 | 12.001 |
| (bar) | | | | | | | |
| Density | 1044.1 | 1094.5 | 1088.1 | 1096.9 | 1090.2 | 1074.1 | 1092.5 |
| (kg/m³) | | | | | | | |
| Volume | 0.0009578 | 0.0009137 | 0.000919 | 0.0009117 | 0.0009173 | 0.000931 | 0.0009154 |
| (m³/kg) | | | | | | | |
| Int. Energy | 235.1 | 235.67 | 235.98 | 236.6 | 236.84 | 236.39 | 236.86 |
| (kj/kg) | | | | | | | |
| Enthalpy | 236.3 | 236.8 | 237.24 | 237.71 | 238.08 | 237.51 | 237.96 |
| (kj/kg) | | | | | | | |
| Entropy | 1.125 | 1.1269 | 1.1283 | 1.1301 | 1.1312 | 1.1294 | 1.131 |
| (kJ/kg-K) | | | | | | | |
| Cv (kJ/kg-K) | 0.92472 | 0.91223 | 0.91282 | 0.92106 | 0.92174 | 0.92817 | 0.92321 |
| Cp (kJ/kg-K) | 1.5423 | 1.5433 | 1.5647 | 1.5768 | 1.5949 | 1.5706 | 1.585 |
| Cp/Cv | 1.6678 | 1.6918 | 1.7142 | 1.7119 | 1.7303 | 1.692 | 1.7168 |
| Molar | 97.604 | 87.488 | 85.403 | 81.133 | 79.813 | 84.083 | 79.189 |
| mass(Kg/K | | | | | | | |
| Thermal | 62.714 | 80.781 | 81.734 | 87.494 | 87.911 | 82.914 | 90.662 |
| conductivity | | | | | | | |
| (mW/m-K) | | | | | | | |
| Viscosity | 128.27 | 139.22 | 136.74 | NA | 142.16 | 139.1 | 144.54 |
| (uPa-s) | | | | | | | |

TABLE 7
Analysis at 25° C. in vapor phase

| | R404a | C-1 | C-1a | C-2 | C-2a | C-3 | C-4 |
|---|---|---|---|---|---|---|---|
| Pressure | 12.412 | 10.597 | 11.053 | 10.488 | 10.856 | 10.358 | 10.249 |
| (bar) | | | | | | | |
| Density | 65.274 | 46.78 | 47.564 | 42.555 | 43.271 | 43.714 | 40.394 |
| (kg/m³) | | | | | | | |
| Volume | 0.01532 | 0.021377 | 0.021024 | 0.023499 | 0.02311 | 0.022876 | 0.024756 |
| (m³/kg) | | | | | | | |
| Int. Energy | 357.54 | 387.83 | 389.41 | 405.42 | 405.91 | 396.67 | 411.39 |
| (kJ/kg) | | | | | | | |
| Enthalpy | 376.55 | 410.48 | 412.65 | 430.06 | 431 | 420.37 | 436.76 |
| (kJ/kg) | | | | | | | |
| Entropy | 1.5958 | 1.7156 | 1.7251 | 1.7819 | 1.7873 | 1.7491 | 1.805 |
| (kJ/kg-K) | | | | | | | |
| Cv (kJ/kg-K) | 0.89151 | 0.86448 | 0.86028 | 0.86835 | 0.86339 | 0.87388 | 0.86943 |
| Cp (kJ/kg-K) | 1.2214 | 1.1499 | 1.149 | 1.1705 | 1.1658 | 1.1634 | 1.1719 |
| Cp/Cv | 1.3701 | 1.3302 | 1.3356 | 1.3479 | 1.3502 | 1.3313 | 1.3478 |
| Molar | 97.604 | 87.488 | 85.403 | 81.133 | 79.813 | 84.083 | 79.189 |
| mass(Kg/ | | | | | | | |
| Kmol) | | | | | | | |
| Thermal | 17.003 | 14.581 | 14.725 | NA | 14.671 | 14.603 | 14.497 |
| conductivity | | | | | | | |
| Viscosity | 12.229 | 12.334 | 12.446 | NA | 12.239 | 12.205 | 12.055 |
| (uPa-s) | | | | | | | |

TABLE 8
Analysis at −25° C. in liquid phase

| | R404a | C-1 | C-1a | C-2 | C-2a | C-3 | C-4 |
|---|---|---|---|---|---|---|---|
| Pressure | 2.5373 | 2.4395 | 2.9446 | 2.374 | 2.8548 | 2.3782 | 2.3367 |
| (bar) | | | | | | | |
| Density | 1238.6 | 1277.9 | 1273.9 | 1275.5 | 1270.8 | 1251 | 1268.1 |
| (kg/m³) | | | | | | | |
| Volume | 0.0008074 | 0.0007825 | 0.000785 | 0.000784 | 0.0007869 | 0.0007993 | 0.0007886 |
| (m³/kg) | | | | | | | |
| Int. Energy | 166.21 | 165.42 | 164.99 | 164.43 | 164.08 | 164.71 | 164.17 |
| (kJ/kg) | | | | | | | |
| Enthalpy | 166.41 | 165.61 | 165.22 | 164.62 | 164.3 | 164.9 | 164.36 |
| (kJ/kg) | | | | | | | |
| Entropy | 0.87225 | 0.86912 | 0.86775 | 0.86529 | 0.86419 | 0.86636 | 0.86426 |
| (kJ/kg-K) | | | | | | | |
| Cv (kJ/kg-K) | 0.84874 | 0.85464 | 0.85658 | 0.86776 | 0.86957 | 0.87164 | 0.8712 |
| Cp (kJ/kg-K) | 1.3008 | 1.3359 | 1.3506 | 1.3775 | 1.3893 | 1.3647 | 1.3879 |
| Cp/Cv | 1.5327 | 1.5631 | 1.5768 | 1.5874 | 1.5977 | 1.5657 | 1.593 |
| Molar | 97.604 | 87.488 | 85.403 | 81.133 | 79.813 | 84.083 | 79.189 |
| mass(Kg/ | | | | | | | |
| Kmol) | | | | | | | |
| Thermal | 82.918 | 104.76 | 106.5 | 113.14 | 114.18 | 107.19 | 116.86 |
| conductivity | | | | | | | |
| (mW/m-K) | | | | | | | |
| Viscosity | 249.25 | 257.95 | 254.24 | 267.16 | 263.01 | 256.47 | 264.85 |
| (uPa-s) | | | | | | | |

TABLE 9
Analysis at −25° C. in vapour phase

| | R404a | C-1 | C-1a | C-2 | C-2a | C-3 | C-4 |
|---|---|---|---|---|---|---|---|
| Pressure | 2.4752 | 1.8868 | 1.9658 | 1.8199 | 1.8824 | 1.8331 | 1.7662 |
| (bar) | | | | | | | |
| Density | 12.797 | 8.5463 | 8.6866 | 7.6199 | 7.7484 | 7.9673 | 7.2074 |
| (kg/m³) | | | | | | | |
| Volume | 0.078143 | 0.11701 | 0.11512 | 0.13124 | 0.12906 | 0.12551 | 0.13875 |
| (m³/kg) | | | | | | | |
| Int. Energy | 332.99 | 363.94 | 365.84 | 382.76 | 383.39 | 372.67 | 388.78 |
| (kJ/kg) | | | | | | | |
| Enthalpy | 352.33 | 386.02 | 388.47 | 406.65 | 407.69 | 395.68 | 413.29 |
| (kJ/kg) | | | | | | | |
| Entropy | 1.6226 | 1.7697 | 1.7839 | 1.8542 | 1.8629 | 1.8092 | 1.8821 |
| (kJ/kg-K) | | | | | | | |
| Cv (kJ/kg-K) | 0.7316 | 0.70979 | 0.70677 | 0.70638 | 0.70355 | 0.71639 | 0.70698 |
| Cp (kJ/kg-K) | 0.86763 | 0.84931 | 0.84863 | 0.85589 | 0.85418 | 0.86028 | 0.8589 |
| Cp/Cv | 1.1859 | 1.1966 | 1.2007 | 1.2117 | 1.2141 | 1.2009 | 1.2149 |
| Molar | 97.604 | 87.488 | 85.403 | 81.133 | 79.813 | 84.083 | 79.189 |
| mass(Kg/ | | | | | | | |
| Kmol) | | | | | | | |
| Thermal | 10.868 | 9.9927 | 10.086 | 9.9796 | 10.06 | 9.9472 | 9.9594 |
| conductivity | | | | | | | |
| (mW/m-K) | | | | | | | |
| Viscosity | 10.039 | 10.111 | 10.211 | 10.035 | 10.117 | 10.004 | 9.9637 |
| (uPa-s) | | | | | | | |

1. A refrigerant composition comprising:
10% by weight to 35% by weight of R32;
10% by weight to 35% by weight of R1234yf;
20% by weight to 50% by weight of tetrafluoroethane, and
one or more additional compounds selected from
0% to 20% by weight of R125;
0% to 10% by weight of heptafluoropropane;
0% to 10% by weight of difluoroethane; and
0% to 8% by weight of CO2.

2. The refrigerant composition as claimed in claim 1, wherein the composition comprises:
23% by weight to 27% by weight of R32;
28% by weight to 32% by weight of R1234yf;
13% by weight to 17% by weight of R125;
23% by weight to 27% by weight of tetrafluoroethane;
3% by weight to 7% by weight of heptafluoropropane; and
0.5% by weight to 2% by weight of CO2.

3. The refrigerant composition as claimed in claim 1, wherein the composition comprises:
25% by weight to 26% by weight of R32;
30% by weight to 31% by weight of R1234yf;
15% by weight to 16% by weight of R125;
25% by weight to 26% by weight of R134a; and
5% by weight to 6% by weight of R227ea.

4. The refrigerant composition as claimed in claim 1, wherein the composition comprises:
28% by weight to 32% by weight of R32;
12% by weight to 16% by weight of R1234yf;
8% by weight to 12% by weight of R125;
43% by weight to 47% by weight of R134a; and
0.5% by weight to 2% by weight of CO2.

5. The refrigerant composition as claimed in claim 1, wherein the composition comprises:
25% by weight to 30% by weight of R32;
10% by weight to 15% by weight of R1234yf;
8% by weight to 15% by weight of R125; and
40% by weight to 50% by weight of 134a.

6. The refrigerant composition as claimed in claim 1, wherein the composition comprises:
23% by weight to 27% by weight of R32;
28% by weight to 32% by weight of R1234yf;
13% by weight to 17% by weight of R125;
23% by weight to 27% by weight of 134a; and
3% by weight to 7% by weight of R152a.

7. The refrigerant composition as claimed in claim 1, wherein the composition comprises:
30% by weight to 35% by weight of R32;
13% by weight to 17% by weight of R1234yf;
42% by weight to 48% by weight of 134a; and
4% by weight to 6% by weight of R227ea.

8. The refrigerant composition of claim 1 that has a Global Warming Potential of less than 1500.

9. The refrigerant composition compositions of claim 1, wherein the refrigerant composition is a non-azeotropic composition.

10. The refrigerant composition of claim 1, wherein the refrigerant composition is used as a replacement for 404A.
